(19) United States
(12) Patent Application Publication
(10) Pub. No.: US 2014/0285442 A1
(43) Pub. Date: Sep. 25, 2014

(54) METHOD FOR INPUTTING CHARACTERS AND APPARATUS FOR THE SAME

(71) Applicant: ELECTRONICS AND TELECOMMUNICATIONS RESEARCH INSTITUTE, Daejeon (KR)

(72) Inventors: Hyuk JEONG, Daejeon (KR); Jae Ho LEE, Daejeon (KR); Kwang Hyun SHIM, Daejeon (KR)

(73) Assignee: ELECTRONICS AND TELECOMMUNICATIONS RESEARCH INSTITUTE, Daejeon (KR)

(21) Appl. No.: 14/191,324

(22) Filed: Feb. 26, 2014

(30) Foreign Application Priority Data
Mar. 20, 2013 (KR) 10-2013-0029656

(51) Int. Cl. G06F 3/023; G06F 3/041

(52) U.S. Cl. CPC G06F 3/0236; G06F 3/041
USPC 345/171

(57) ABSTRACT

A method performed in an apparatus based on touch screen may comprise grouping Korean consonants into at least one consonant-group and Korean vowels into at least one vowel-group and determining a delegate consonant for each of the at least one consonant-group and a delegate vowel for each of the at least one vowel-group; allocating the delegate consonant and the delegate vowel to independent keys in a predetermined order, and displaying the keys; and displaying at least one key corresponding to at least one family consonant belonging to a same group with the delegate consonant to a key selected among the displayed keys. Therefore, all Korean consonants and vowels can be inputted by using a restricted number of keys, and inputted quickly and easily without any learning or training.

### CLAIM FOR PRIORITY

This application claims priorities to Korean Patent Application No. 10-2013-0029656 filed on Mar. 20, 2013 in the Korean Intellectual Property Office (KIPO), the entire contents of which are hereby incorporated by references.

### BACKGROUND

1. Technical Field

Example embodiments of the present invention relate to a method for inputting characters, and more specifically to a method for inputting characters which can enhance convenience of use, and an apparatus performing the same.

2. Related Art

A touch screen is an input/output device identifying commands from a user by recognizing touch operations of the user while displaying image on the screen. Recently, touch screen is being used as main input/output means in a portable information device such as a smart phone, etc.

In portable information devices based on touch screen, a ‘QWERTY’ type input scheme, in which arrangement of keys corresponding to characters like a computer keyboard is displayed as it is, is being used. Also, in small portable devices equipped with touch screen having small display region, key arrangement, comprising four rows and three columns to which consonants and vowels are allocated, is being widely used.

For example, one of methods for inputting Korean characters, an input method of ‘Chon-ji-in’ is an input method in which seven keys are allocated for inputting Korean consonants, three keys are allocated for three strokes (‘ [symbol] ’, ‘.’, and ‘-’) constituting Korean vowels, and Korean character are inputted by combining the allocated keys. The above input method is characterized in using a small number of keys for Korean vowels (only three keys for vowels). However, even in a case in which Korean vowels having high frequency of uses such as ‘ [symbol] ’, ‘ [symbol] ’, ‘ [symbol] ’, ‘ [symbol] ’, etc. are inputted, two keys should be selected sequentially in the input method of ‘Chon-ji-in’. For example, when a complex vowel such as ‘ [symbol] ’ is to be inputted, five keys should be selected sequentially for inputting it. Therefore, the conventional Korean character input methods such as the input method of ‘Chon-ji-in’ have shortcomings of requiring a number of key operations for inputting some complex characters.

Meanwhile, in a Korean published patent application No. 10-2005-008836, in order to resolve the above mentioned shortcoming of the input method of ‘Chon-ji-in’, disclosed is an input method for inputting Korean vowels by adjusting touch durations for each of a long horizontal bar-type key and a vertical bar-type key. However, in the above disclosed technique, there is a shortcoming that users should be familiar with adjusting touch durations in order to reducing errors in inputting Korean characters.

Also, in an input method of ‘Naratgeul’ among methods for inputting Korean characters, six keys are allocated for inputting Korean consonants, and two functional keys are used for switching consonants. For example, in order to input vowels, four keys allocated for inputting ‘ [symbol] ’, ‘ [symbol] ’, ‘ [symbol] ’, and ‘ [symbol] ’ a functional key allocated for inputting vowel characters such as ‘ [symbol] ’ are used.

Since the conventional methods for inputting Korean characters which were explained above require users to be familiar with configuration and key arrangement of a keyboard through learning and training, there is a problem that significant time is demanded until users have abilities of inputting Korean characters quickly and freely.

That is, since a keyboard for computer and a keypad equipped in a conventional portable terminal have complex configuration and key arrangements, learning and training for inputting characters are necessary in order to input Korean character quickly and correctly.

Therefore, when the conventional input methods which are described above are used in devices having low frequency of input such as a navigation apparatus, a kiosk system, etc., there can be problems of increasing time required for inputting characters and typographical errors.

### SUMMARY

Accordingly, example embodiments of the present invention are provided to substantially obviate one or more problems due to limitations and disadvantages of the related art.

Example embodiments of the present invention provide a method for inputting characters (especially, Korean characters) quickly and correctly without training or experiences of a user.

Example embodiments of the present invention also provide an apparatus for inputting characters (especially, Korean characters), which performs the above method.

In some example embodiments, a method for inputting characters, performed in an apparatus based on touch screen, may comprise grouping Korean consonants into at least one consonant-group and Korean vowels into at least one vowel-group, and determining delegate consonants each of which corresponds to each of the at least one consonant-group and delegate vowels each of which corresponds to each of the at least one vowel-group; allocating the delegate consonants and the delegate vowels to independent keys in a predetermined order, and displaying the keys; and displaying at least one key corresponding to at least one family consonant belonging to a same group with a delegate consonant corresponding to a key selected among the displayed keys.

Here, the Korean consonants and the Korean vowels may be grouped based on at least one of shapes and sounds of the Korean consonants and the Korean vowels.

Here, the at least one consonant-group may include { [symbol] , [symbol] , [symbol] }, { [symbol] , [symbol] , [symbol] }, { [symbol] , [symbol] , [symbol] }, { [symbol] , [symbol] }, { [symbol] , [symbol] , [symbol] }, { [symbol] , [symbol] }, { [symbol] }, { [symbol] }, and { [symbol] }, and the delegate consonants for the at least one consonant-group may be respectively configured as ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, and ‘ [symbol] ’.

Here, the delegate consonants for the Korean consonants may be nine consonants, and may be displayed in a keyboard comprising 3 rows and 3 columns on the touch screen according to Korean alphabetical order.

Here, in the displaying at least one key corresponding to at least one family consonant belonging to the same group with the delegate consonant to the key selected among the displayed keys, the at least one key corresponding to the at least one family consonant may be displayed in a predetermined position adjacent to the selected key, and the predetermined position may include upper side, lower side, left side, right side, lower-right side of the selected key.

Here, the at least one key corresponding to the at least one family consonant may be displayed in the left or right side of the selected key when the at least one family consonant is corresponding to a double consonant, and the at least one key corresponding to the at least one family consonant may be displayed in the upper or lower side of the selected key when the at least one family consonant is corresponding to an aspirated consonant.

Here, the at least one vowel-group may include { [symbol] , [symbol] }, { [symbol] , [symbol] }, { [symbol] , [symbol] }, { [symbol] , [symbol] }, { [symbol] }, and { [symbol] }, and the delegate vowels for the at least one vowel-group may be respectively configured as ‘ [symbol] ’, ‘ [symbol] ’, ‘ [symbol] ’, ‘ [symbol] ’, ‘ [symbol] ’, and ‘ [symbol] ’.

Here, the at least one vowel-group may include { [symbol] , [symbol] }, { [symbol] , [symbol] }, { [symbol] , [symbol] }, { [symbol] , [symbol] }, and { [symbol] , [symbol] }, and the delegate vowels for the at least one vowel-group may be respectively configured as ‘ [symbol] ’, ‘ [symbol] ’, ‘ [symbol] ’, ‘ [symbol] ’, and ‘ [symbol] ’.

Here, the delegate consonants and the delegate vowels may be displayed in a form of a QWERTY type keyboard, and other consonants except the delegate consonants are not allocated to keys allocated to the delegate consonants, and other vowels except the delegate vowels are not allocated to keys allocated to the delegate vowels.

Here, in the displaying at least one key corresponding to at least one family consonant belonging to the same group with the delegate consonant to a key selected among the displayed keys, when a key corresponding to one of ‘ [symbol] ’, ‘ [symbol] ’, ‘ [symbol] ’, ‘ [symbol] ’, and ‘ [symbol] ’ is selected, at least one double consonant corresponding to a consonant allocated to the selected key may be displayed in the upper side of the selected key.

Here, the method for inputting characters may further comprise displaying at least one key corresponding to at least one family vowel belonging to a same group with the delegate vowel corresponding to a key selected among the displayed keys.

Here, in the displaying at least one key corresponding to at least one family consonant belonging to the same group with the delegate consonant to the key selected among the displayed keys, a key corresponding to ‘ [symbol] ’ may be displayed in the upper side of a key corresponding to ‘ [symbol] ’ when the key corresponding to ‘ [symbol] ’ is selected, and a key corresponding to ‘ [symbol] ’ may be displayed in the upper side of a key corresponding to ‘ [symbol] ’ when the key corresponding to ‘ [symbol] ’ is selected.

In other example embodiments, an apparatus for inputting characters may comprise a touch screen displaying independent keys which are allocated to delegate consonants each of which corresponds to each of a plurality of Korean consonant-groups and delegate vowels each of which corresponds to each of a plurality of Korean vowel-groups, and generating a touch signal of a key selected among the displayed keys; and a processing part receiving the touch signal, and controlling the touch screen to display at least one key corresponding to at least one family consonant belonging to a same group with the delegate consonant corresponding to the key selected among the displayed keys.

Here, the touch screen may display the delegate consonants in a keyboard comprising 3 rows and 3 columns according to Korean alphabetical order.

Here, the processing part may control the touch screen to display the at least one key corresponding to the at least one family consonant in a predetermined position adjacent to the selected key, and the predetermined position may include upper side, lower side, left side, right side, and lower-right side of the selected key.

Here, the touch screen may display the delegate consonants and the delegate vowels in a form of a QWERTY type keyboard, and display a double consonant corresponding to a delegate consonant allocated to the selected key in upper side of the selected key when the selected key is corresponding to one of ‘ [symbol] ’, ‘ [symbol] ’, ‘ [symbol] ’, ‘ [symbol] ’, and ‘ [symbol] ’, according to control of the processing part.

Here, the touch screen displays the delegate consonants and the delegate vowels in a form of a QWERTY type keyboard, display a key corresponding to ‘ [symbol] ’ in an upper side of a key corresponding to ‘ [symbol] ’ according to control of the processing part when the key corresponding to ‘ [symbol] ’ is selected, and display a key corresponding to ‘ [symbol] ’ in an upper side of a key corresponding to ‘ [symbol] ’ according to control of the processing part when the key corresponding to ‘ [symbol] ’ is selected.

### BRIEF DESCRIPTION OF DRAWINGS

Example embodiments of the present invention will become more apparent by describing in detail example embodiments of the present invention with reference to the accompanying drawings, in which:

FIG. 1 is a view to explain a configuration of keyboard according to Korean alphabetical order;

FIGS. 2A to 2C are tables to explain examples of grouping Korean consonants and vowels according to the present invention;

FIGS. 3A and 3B are conceptual diagrams to show examples of key arrangement for grouped Korean consonants and vowels according to an example embodiment of the present invention;

FIG. 4 is a conceptual diagram to illustrate an example of inputting vowels when 6 keys are allocated for Korean vowels in an example embodiment of the present invention;

FIG. 5 is a conceptual diagram to illustrate an example of inputting vowels when 5 keys are allocated for Korean vowels in an example embodiment of the present invention;

FIG. 6 is a conceptual diagram to illustrate a configuration of keyboard for inputting Korean characters which may be used in a method according to an example embodiment of the present invention;

FIG. 7 is a conceptual diagram to explain a method of inputting Korean characters using a keyboard for inputting Korean characters according to an example embodiment of the present invention;

FIGS. 8A to 8E are conceptual diagrams to explain methods for displaying family consonants in a method for inputting Korean characters using a keyboard for inputting Korean characters according to an example embodiment of the present invention;

FIG. 9 is a conceptual diagram to explain another method for displaying family consonants in a method for inputting Korean characters using a keyboard for inputting Korean characters according to an example embodiment of the present invention;

FIGS. 10A and 10B are conceptual diagrams to illustrate other configurations of keypad for inputting Korean characters which may be used in a method according to an example embodiment of the present invention;

FIG. 11 is a flow chart to explain a method for inputting characters according to an example embodiment of the present invention; and

FIG. 12 is a block diagram to show a configuration of an apparatus for inputting characters according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Considering keyboards for computers or portable terminals, in order to input modern Korean characters, 19 consonants ( [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] ) and 10 vowels ( [symbol] , [symbol] , [symbol] , [symbol] , [symbol] , [symbol] , [symbol] , [symbol] , [symbol] , [symbol] ) should be allocated to keys. When 29 keys are configured as described above, all Korean characters can be inputted by using the 29 keys.

For example, complex consonants and complex vowels such as ‘ [symbol] ’, ‘ [symbol] ’, etc. can be inputted by sequentially combining 19 keys allocated for 19 consonants and 10 keys allocated for 10 vowels.

Therefore, if the entire 29 keys are allocated for the 29 consonants and vowels, a conventional Korean input method (for example, referred to as ‘Doobeol-sik (two set type)’) can be used as it is in order to input Korean characters.

However, in devices having low frequency of input such as a navigation apparatus, a kiosk system, etc., it is more usable to configure a keyboard with a simple rule such as order of ‘ [symbol] ’ as compared with the conventional configuration of keyboard.

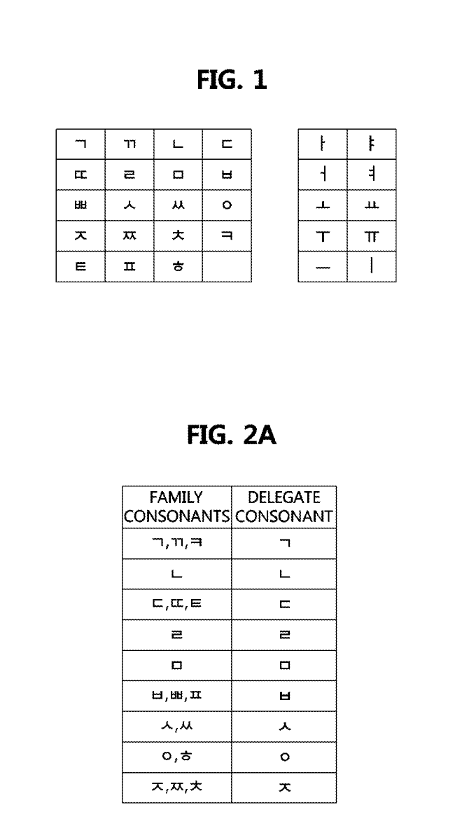

FIG. 1 is a view to explain a configuration of keyboard according to Korean alphabetical order, and shows an example in which 19 Korean consonants and 10 Korean vowels are allocated to independent keys respectively, and keys are sequentially arranged in order of ‘ [symbol] ’, that is, in Korean alphabetical order.

In a keyboard illustrated in FIG. 1, since Korean consonants and vowels are arranged with a simple rule, users can find desired keys easily. However, the keyboard has too many key, 29 keys, and so there can be a shortcoming of low efficiency in inputting characters since sequential search from a first key of the keyboard is necessary when a key desired by a user is positioned in an ending portion of the keyboard.

Also, key arrangement shown in FIG. 1 has too many keys, and so cannot be applied to a device having small region for displaying the keyboard. Even when it is applied to the device, efficiency of use becomes decreased since size of keys and spaces between keys are small.

In order to resolve problems which are described above, the present invention provides a design of key arrangement which can make users recognize desired keys easily, a method for inputting characters efficiently using a restricted number of keys without additional learning or training about key arrangement, and an apparatus performing the method for inputting characters.

In order for users to recognize keys to which Korean consonants and vowels are allocated easily, it is more efficient that consonants and vowels are grouped into several groups, and delegate consonants or vowels for each group are used for inputting other consonants and vowels as compared with a case in which 19 consonants and 10 vowels are allocated to independent keys respectively.

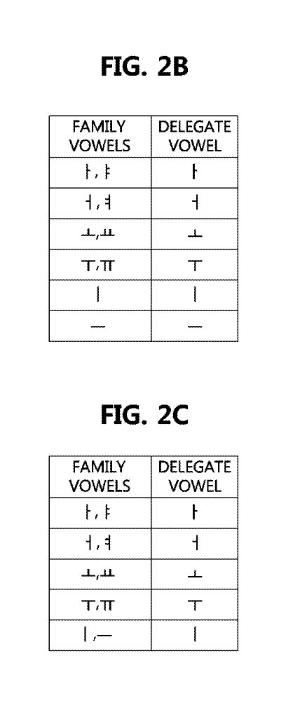

FIGS. 2A to 2C are tables to explain examples of grouping Korean consonants and vowels according to the present invention.

In a method for inputting characters according to an example embodiment of the present invention, an example in which Korean consonants and vowels are grouped into a predetermined number of groups is shown in FIGS. 2A to 2C. For example, consonants and vowels may be classified into groups according to their shapes or sounds as shown in FIGS. 2A to 2C.

Referring to FIG. 2A, Korean consonants may be classified into lax consonants such as ‘ [symbol] ’, etc., double consonants such as ‘ [symbol] ’, etc., and aspirated consonants such as ‘ [symbol] ’. Accordingly, Korean consonants may be grouped into { [symbol] , [symbol] , [symbol] }, { [symbol] , [symbol] , [symbol] }, { [symbol] , [symbol] , [symbol] }, { [symbol] , [symbol] }, and { [symbol] , [symbol] , [symbol] }. Each of the groups has family consonants having similar shapes and sounds.

Also, when consonants are classified in reference to shapes of consonants, ‘ [symbol] ’ and ‘ [symbol] ’ which have similar shapes may be grouped into a group.

As described above, Korean consonants may be classified into nine groups according to shapes and/or sounds of consonants, and delegate consonants for the groups may be configured as ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, and ‘ [symbol] ’.

Also, each of { [symbol] }, { [symbol] }, and { [symbol] } is a group having only single element, and a delegate consonant for each of them may configured as ‘ [symbol] ’, ‘ [symbol] ’ and ‘ [symbol] ’ respectively.

Meanwhile, referring to FIG. 2B, 10 Korean vowels may be classified into 6 groups { [symbol] , [symbol] }, { [symbol] , [symbol] }, { [symbol] , [symbol] }, { [symbol] , [symbol] }, { [symbol] }, and { [symbol] }. Delegate vowels for each of the groups may be configured as ‘ [symbol] ’, ‘ [symbol] ’, ‘ [symbol] ’, ‘ [symbol] ’, ‘ [symbol] ’, and ‘ [symbol] ’.

Alternatively, ‘ [symbol] ’ and ‘ [symbol] ’ may be grouped into a single group. Therefore, 5 family groups and 5 delegate vowels for them may be configured as shown in FIG. 2C.

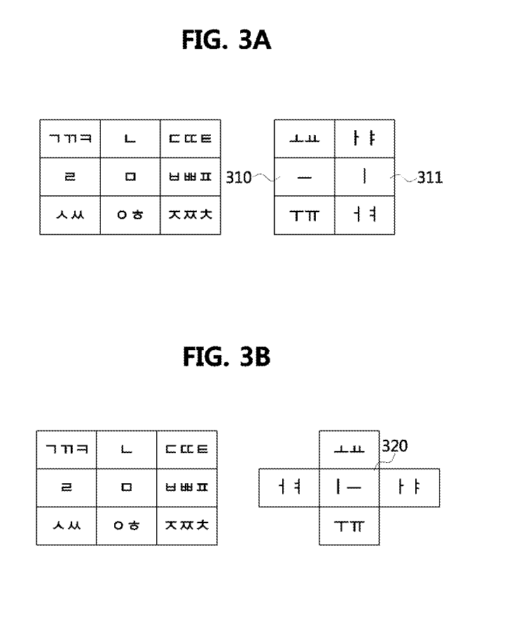

FIGS. 3A and 3B are conceptual diagrams to show examples of key arrangement for grouped Korean consonants and vowels according to an example embodiment of the present invention.

FIG. 3A represent an example in which 9 keys are allocated for grouped Korean consonants and 6 keys are allocated for grouped Korean vowels, and FIG. 3B represents an example in which 9 keys are allocated for grouped Korean consonants and 5 keys are allocated for grouped Korean vowels.

That is, an example shown in FIG. 3A and an example shown in FIG. 3B have identical key arrangement for grouped consonants and different key arrangement for grouped vowels. In FIG. 3A, ‘ [symbol] ’ and ‘ [symbol] ’ are allocated to separate keys 310 and 311. In FIG. 3B, ‘ [symbol] ’ and ‘ [symbol] ’ are allocated to a single key 320.

Meanwhile, when keys for consonants and vowels are arranged as shown in FIGS. 3A and 3B, 21 Korean vowels can be inputted in a ‘multi-tap’ manner. Here, the ‘multi-tap’ manner means an input method in which multiple characters are allocated to a single key, and pushing or touching the same key continuously makes a character be selected among multiple characters allocated to the same key according to a predetermined order.

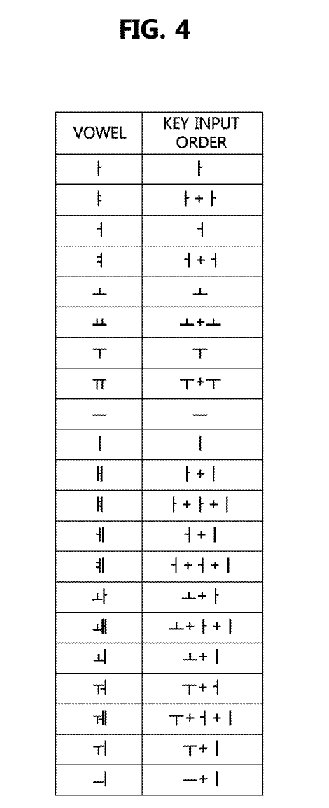

FIG. 4 is a conceptual diagram to illustrate an example of inputting vowels when 6 keys are allocated for Korean vowels in an example embodiment of the present invention. That is, FIG. 4 shows an input method for 21 Korean vowels when 6 keys are allocated for vowels grouped as shown in FIG. 3A.

Referring to FIG. 4, since ‘ [symbol] ’, ‘ [symbol] ’, ‘ [symbol] ’, ‘ [symbol] ’, ‘ [symbol] ’, and ‘ [symbol] ’ among 21 Korean vowels are delegate vowels for 6 vowel groups, they can be inputted by touching (or, pushing) corresponding key only one time.

Meanwhile, double vowels ‘ [symbol] ’, ‘ [symbol] ’, ‘ [symbol] ’, and ‘ [symbol] ’ may be inputted by touching (or, pushing) corresponding key, respectively, ‘ [symbol] ’, ‘ [symbol] ’, ‘ [symbol] ’, and ‘ [symbol] ’, two times continuously.

Other Korean vowels except the vowels described above may be inputted by touching corresponding keys sequentially according to writing order of each vowel. For example, when ‘ [symbol] ’ is desired to be inputted, a key of ‘ [symbol] ’ which is a delegate vowel for ‘ [symbol] ’ is touched two times for inputting “ [symbol] ’, and then ‘ [symbol] ’ is touched. That is, in order to input ‘ [symbol] ’, ‘ [symbol] ’, ‘ [symbol] ’, and ‘ [symbol] ’ keys need to be touched (or, pushed) sequentially.

As another example, when ‘ [symbol] ’ is desired to be inputted, ‘ [symbol] ’, ‘ [symbol] ’, and ‘ [symbol] ’ keys need to be touched (or, pushed) sequentially.

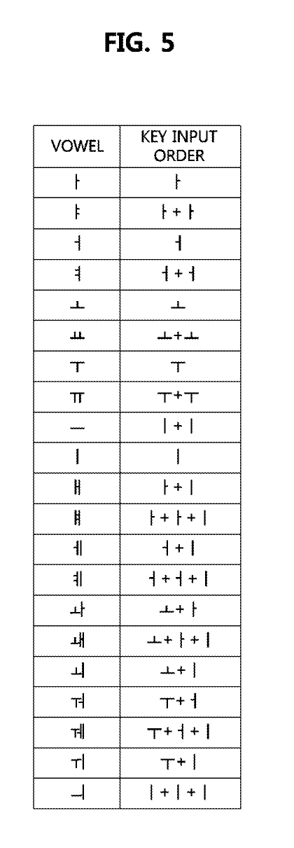

FIG. 5 is a conceptual diagram to illustrate an example of inputting vowels when 5 keys are allocated for Korean vowels in an example embodiment of the present invention. That is, FIG. 5 shows an input method of 21 Korean vowels when 5 keys are allocated for vowels grouped as shown in FIG. 3B.

The input method depicted in FIG. 5 is similar to that of FIG. 4. However, since ‘ [symbol] ’ and ‘ [symbol] ’ are grouped into a group and ‘ [symbol] ’ is configured as a delegate vowel for the group, input methods for vowels ‘ [symbol] ’ and ‘ [symbol] ’ are different from the method depicted in FIG. 4.

That is, when ‘ [symbol] ’ is desired to be inputted, a key allocated to ‘ [symbol] ’ which is a delegate vowel for ‘ [symbol] ’ is touched two times continuously for inputting ‘ [symbol] ’. Also, when ‘ [symbol] ’ is desired to be inputted, a key allocated to ‘ [symbol] ’ is touched three times continuously.

Hereinafter, a method for displaying keys for Korean consonants and inputting Korean consonants according to an example embodiment of the present invention will be explained in detail.

The input manner of ‘multi-tap’ may be applied to inputting Korean consonants similarly to the method for inputting vowels which is described above. However, due to characteristic of Korean consonant input scheme, when a final consonant and a beginning consonant in continuous two characters are the same consonant, a process for separating characters is required to be performed by user. For example, when a word ‘ [symbol] ’ is desired to be inputted, since a final consonant ‘ [symbol] ’ of the first character ‘ [symbol] ’ and a beginning consonant ‘ [symbol] ’ of the second character ‘ [symbol] ’ should be inputted continuously, it is necessary to separate characters ‘ [symbol] ’ and ‘ [symbol] ’. Therefore, there can be inconveniency that user should separate characters by manipulating an arrow key or a functional key between ‘ [symbol] ’ and ‘ [symbol] ’.

In a method for inputting characters according to an example embodiment of the present invention, provided is a method for inputting Korean consonants efficiently by using a restricted number of keys in consideration of the problem described above.

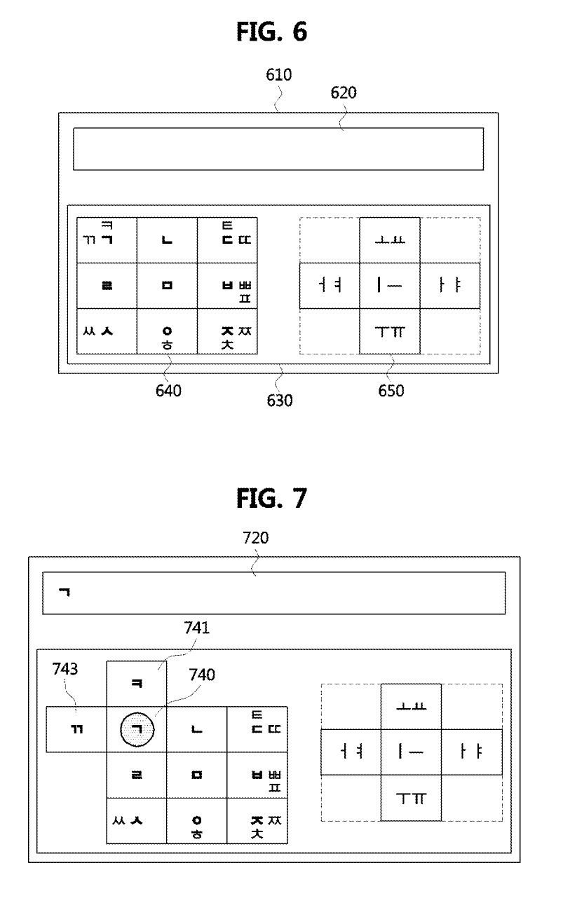

FIG. 6 is a conceptual diagram to illustrate a configuration of keyboard for inputting Korean characters which may be used in a method according to an example embodiment of the present invention. A case in which keys for Korean consonants and vowels are displayed in a touch screen 610 is illustrated as an example.

Referring to FIG. 6, a method for inputting characters according to the present invention may be performed in an apparatus based on a touch screen 610, and a display region of the touch screen 610 may include a region 620 for displaying inputted characters and a region 630 for displaying keys to which Korean consonants and vowels are allocated.

The region 620 is a display region in which a character corresponding to a key which is currently touched and characters which have been inputted.

In the region 630, keys 640 for consonants and keys 650 for vowels are displayed. As shown in FIG. 6, the keys 640 and the keys 650 may be displayed with a preconfigured distance to be recognized easily by users. However, the keys 640 and the keys 650 may be displayed adjacently without any distance.

Also, keys 640 and keys 650 may be located from side to side as shown in FIG. 6. For example, keys 640 for consonants may be located in the left area of the touch screen, and keys 650 for vowels may be located in the right area of the touch screen. Alternatively, keys 640 for consonants and keys 650 for vowels may be located in the upper area and in the lower area of the touch screen.

In keys 640 for consonants, 9 delegate consonants (for example, [symbol] , [symbol] , [symbol] , [symbol] , [symbol] , [symbol] , [symbol] , [symbol] ) may be arranged in 3 by 3 keys on the touch screen 610 in order of ‘ [symbol] ’ (that is, Korean alphabetical order). In a center of each of the keys, delegate consonant corresponding to each of the keys may be displayed largely, or with deep color, or boldly so that the delegate consonants may be differentiated from other consonants.

As shown in FIG. 6, in the present invention, delegate consonants having higher frequency of use than other consonants are allocated to 9 keys. Also, each key has a rectangular shape. Therefore, users can easily identify corresponding keys regardless of learned experiences of users.

On the other hand, other consonants (family consonants except the delegate consonants) related to a delegate consonant may be displayed around the delegate consonant located in center of each key with a smaller size than a size of the delegate consonant. Here, among family consonants related to the delegate consonant, double consonants (such as ‘ [symbol] ’, ‘ [symbol] ’, ‘ [symbol] ’, and ‘ [symbol] ’) may be located in the left area of the delegate consonant or in the right area of the delegate consonant. Also, aspirated consonants (such as ‘ [symbol] ’, ‘ [symbol] ’, and ‘ [symbol] ’) may be located in the upper area or the lower area of the delegate consonant.

Meanwhile, keys 650 for vowels may be arranged as shown in FIG. 3A or FIG. 3B. In FIG. 6, an example in which keys 650 for vowels are arranged as shown in FIG. 4B is represented.

FIG. 7 is a conceptual diagram to explain a method of inputting Korean characters using a keyboard for inputting Korean characters according to an example embodiment of the present invention.

Hereinafter, a method for inputting characters according to the present invention will be explained in further detail by referring to FIG. 7.

First, when a user touches key 740 ‘ [symbol] ’ in keys 640 for consonants, a delegate consonant ‘ [symbol] ’ corresponding to the key 740 is displayed in the display region 720. Simultaneously, family consonants ‘ [symbol] ’ and ‘ [symbol] ’ of the delegate consonant ‘ [symbol] ’ may be created (or popped-up) and displayed respectively in the upper area and the right area of the key 740 as separate keys 741 and 743. Here, the keys 741 and 743 which are created and displayed separately may be configured to have similar shapes and sizes with those of the key 740 of the delegate consonant and displayed adjacently to the key 740. Or, the keys 741 and 743 may be configured to have shapes and sizes different from those of the key 740 for users to identify family consonants easily.

While keys 741 and 743 for the family consonants ‘ [symbol] ’ and ‘ [symbol] ’ of the delegate consonant ‘ [symbol] ’ which are touched by a user are additionally displayed, if the user touches one of keys 741 and 743 for the family consonants, a family consonants corresponding to the touched key may be displayed in the display region 720.

For example, if a user touches the key 743 added in the left side of the key 740 when the keys 741 and 743 correspond to the family consonants, the character ‘ [symbol] ’ which is previously displayed is changed into ‘ [symbol] ’ in the display region 720. Or, when a user touches the key 741 added in the upper side of the key 740, the character ‘ [symbol] ’ which is previously displayed is changed into ‘ [symbol] ’ in the display region 720.

As shown in FIG. 7, according to the present invention, a plurality of consonants are grouped into several groups, delegate consonant for each group is allocated to corresponding key so that the number of keys can be decreased and it becomes easy to search a desired consonant in the keyboard. Also, for inputting family consonants related to corresponding delegate consonant, keys for the family consonants are displayed near the key of the delegate consonant only when the key of the delegate consonant is selected (or touched). Thus, fingering distance of a user may be shortened.

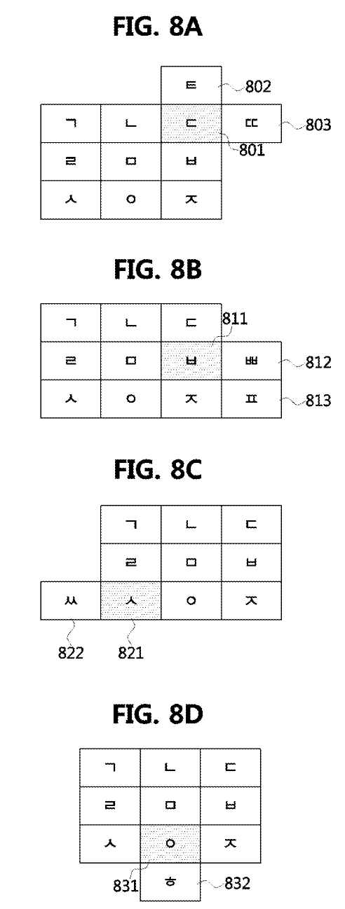

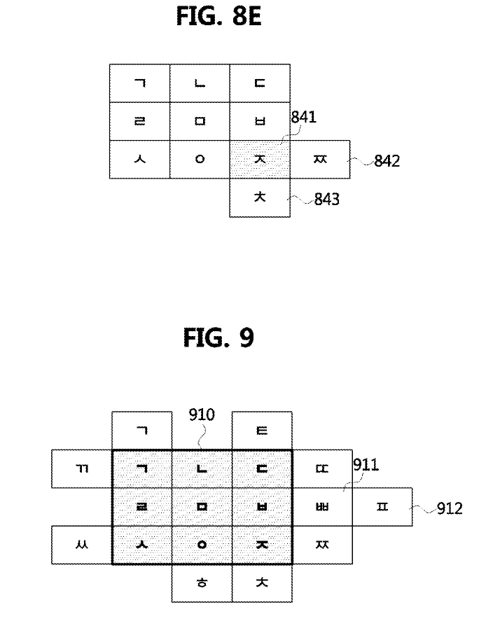

FIGS. 8A to 8E are conceptual diagrams to explain methods for displaying family consonants in a method for inputting Korean characters using a keyboard for inputting Korean characters according to an example embodiment of the present invention.

FIG. 8A is a conceptual diagram to show a case in which family consonants ‘ [symbol] ’ and ‘ [symbol] ’ of the delegate consonant ‘ [symbol] ’ are created and displayed. When a key 801 corresponding to the delegate consonant ‘ [symbol] ’ is touched, a key 802 corresponding to ‘ [symbol] ’ is displayed as expanded from the right side of the key 801 corresponding to ‘ [symbol] ’, and a key 803 corresponding to ‘ [symbol] ’ is displayed as expanded from the upper side of the key 801 corresponding to ‘ [symbol] ’.

FIG. 8B is a conceptual diagram to show a case in which family consonants ‘ [symbol] ’ and ‘ [symbol] ’ of the delegate consonant ‘ [symbol] ’ are created and displayed. When a 811 key corresponding to the delegate consonant ‘ [symbol] ’ is touched, a key 812 corresponding to ‘ [symbol] ’ is displayed as expanded from the right side of the key 811 corresponding to ‘ [symbol] ’, and a key 813 corresponding to ‘ [symbol] ’ is displayed as expanded from the lower side of the key 812 corresponding to ‘ [symbol] ’.

FIG. 8C is a conceptual diagram to show a case in which family consonants ‘ [symbol] ’ of the delegate consonant ‘ [symbol] ’ is created and displayed. When a key 821 corresponding to the delegate consonant ‘ [symbol] ’ is touched, a key 822 corresponding to ‘ [symbol] ’ is displayed as expanded from the left side of the key 821 corresponding to ‘ [symbol] ’.

FIG. 8D is a conceptual diagram to show a case in which family consonants ‘ [symbol] ’ of the delegate consonant ‘ [symbol] ’ is created and displayed. When a key 831 corresponding to the delegate consonant ‘ [symbol] ’ is touched, a key 832 corresponding to ‘ [symbol] ’ is displayed as expanded from the lower side of the key 831 corresponding to ‘ [symbol] ’.

FIG. 8E is a conceptual diagram to show a case in which family consonants ‘ [symbol] ’ and ‘ [symbol] ’ of the delegate consonant ‘ [symbol] ’ are created and displayed. When a key 841 corresponding to the delegate consonant ‘ [symbol] ’ is touched, a key 842 corresponding to ‘ [symbol] ’ is displayed as expanded from the right side of the key 841 corresponding to ‘ [symbol] ’, and a key 843 corresponding to ‘ [symbol] ’ is displayed as expanded from the lower side of the key 841 corresponding to ‘ [symbol] ’.

FIG. 9 is a conceptual diagram to explain another method for displaying family consonants in a method for inputting Korean characters using a keyboard for inputting Korean characters according to an example embodiment of the present invention.

Referring to FIG. 9, 9 delegate consonants (‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’) are allocated to respective independent keys in a key arrangement 910 comprising 3 rows and 3 columns. Family consonants of each delegate consonant are displayed in surrounding area of the keys corresponding to the respective delegate consonants in a similar way with the cases of FIG. 7 and FIGS. 8A to 8E. However, keys for all family consonants and the keys for the delegate consonants are displayed initially at the same time.

However, all the keys for family consonants are displayed at the same time, a family consonant ‘ [symbol] ’ 912 of the delegate consonant ‘ [symbol] ’ is displayed as expanded from the right side of the key corresponding to ‘ [symbol] ’ 911 differently from an example shown in FIG. 8B.

When all the family consonants are displayed simultaneously as shown in FIG. 9, there is an advantage that a user directly can input a desired family consonant by touching a key corresponding to the desired family consonant without touching a key corresponding to a delegate consonant of the desired family consonant. However, since 19 keys allocated to 19 consonants are displayed at the same time, it can be difficult for a user to identify a specific desired key.

In order to resolve the above mentioned problem of difficulty in identifying a desired key, size of keys for the delegate consonants may be configured differently from that of keys for the family consonants. For example, the size of the family consonants is set to smaller than that of the delegate consonants.

Also, each key corresponding to the delegate consonant may have different color, and color of keys corresponding to the family consonants which are belonging to the same group may be set to identical to the color of key corresponding to their delegate consonant in order to make a user identify keys corresponding to a desired family consonant easily and quickly.

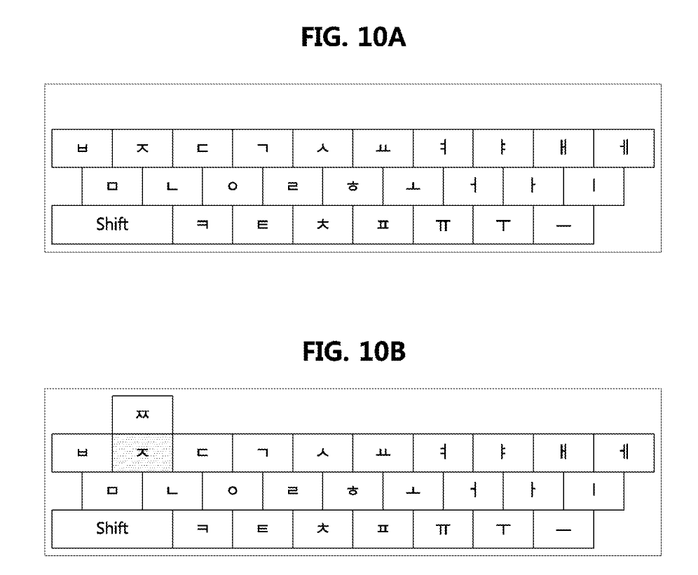

FIGS. 10A and 10B are conceptual diagrams to illustrate other configurations of keyboard for inputting Korean characters which may be used in a method according to an example embodiment of the present invention.

FIG. 10A is a conceptual diagram to illustrate an example of arranging keys for Korean consonants and vowels based on QWERTY type key arrangement. FIG. 10A represents key arrangement which is initially displayed in a touch screen.

In the key arrangement shown in FIG. 10A, ‘ [symbol] ’, ‘ [symbol] ’, ‘ [symbol] ’, ‘ [symbol] ’, and ‘ [symbol] ’ are configured respectively as delegate consonants for family consonants ‘ [symbol] ’, ‘ [symbol] ’, ‘ [symbol] ’, ‘ [symbol] ’, and ‘ [symbol] ’, and ‘ [symbol] ’, and ‘ [symbol] ’ are respectively configured as delegate vowels for family vowels ‘ [symbol] ’, and ‘ [symbol] ’. Accordingly, when one of keys corresponding to the delegate consonants and the delegate vowels is touched, a key for family consonants of family vowels corresponding to the touched key for delegate consonant or vowel is configured to be additionally displayed in the upper side of the touched key.

In other words, as shown in FIG. 10A, in a case in which keys for Korean consonants and vowels are arranged based on a QWERTY type, Korean consonants are grouped into five groups comprising { [symbol] , [symbol] }, { [symbol] , [symbol] }, { [symbol] , [symbol] }, { [symbol] , [symbol] }, and { [symbol] , [symbol] }, and ‘ [symbol] ’, ‘ [symbol] ’, ‘ [symbol] ’, ‘ [symbol] ’, and ‘ [symbol] ’ are configured respectively as a delegate consonant for each group. Also, Korean vowels are grouped into two groups comprising { [symbol] , [symbol] }, and { [symbol] , [symbol] }, and ‘ [symbol] ’ and ‘ [symbol] ’ are configured respectively as a delegate consonant for each group. Also, only keys for the delegate consonants and vowels may be displayed initially. When a key allocated for one of the delegate consonants and vowels is touched, family consonants or vowels related to the touched key may be additionally displayed in the above side of the touched key.

In FIG. 10B, an example in which a key corresponding to ‘ [symbol] ’, one of the delegate consonants is touched in the key arrangement shown in FIG. 10A is represented. For example, when a key corresponding to ‘ [symbol] ’ is touched by a user, a key corresponding to ‘ [symbol] ’ is additionally displayed in the above side of the key corresponding to ‘ [symbol] ’. In this case, if a user touches the key corresponding to ‘ [symbol] ’ which was additionally displayed, ‘ [symbol] ’ is inputted.

By using the input method explained through FIGS. 10A and 10B, it is not necessary that a user touches ‘shift’ key to input one of ‘ [symbol] , [symbol] , [symbol] , [symbol] , [symbol] , [symbol] , [symbol] ’. Thus, an efficiency of inputting characters may be enhanced.

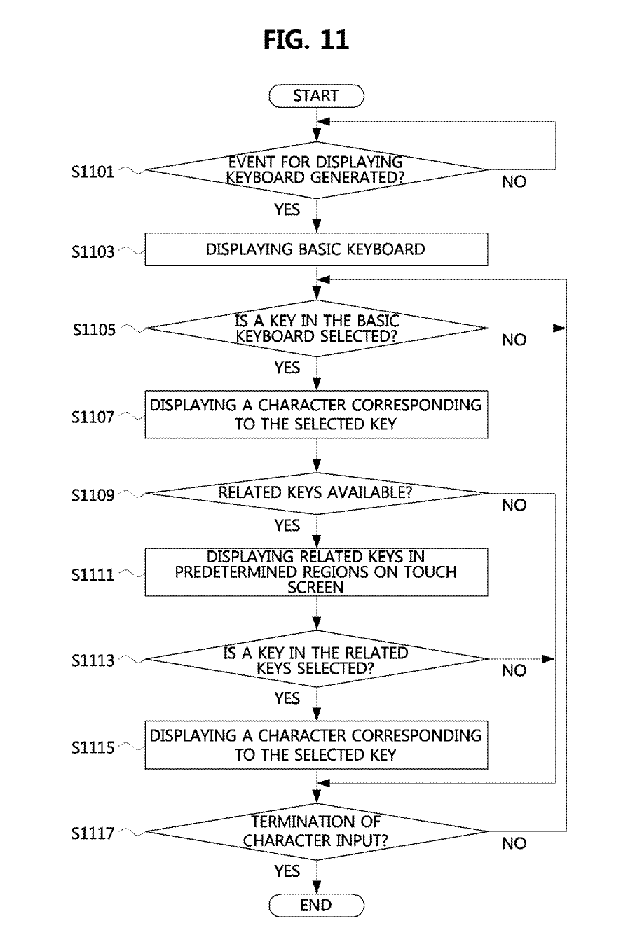

FIG. 11 is a flow chart to explain a method for inputting characters according to an example embodiment of the present invention. An example of a method for inputting characters which is performed in an input apparatus capable of digital signal processing is represented. As shown in FIG. 2, a method of inputting characters in which Korean consonants and vowels are grouped, and delegate consonants and vowels for each group are determined for each group is explained by referring to FIG. 11.

Referring to FIG. 11, first, the input apparatus determines whether an event for displaying keyboard is generated or not at S1101. Here, the input apparatus can identify generation of the event for displaying keyboard when an application related to input of characters is executed or a touch operation (or, key operation) for inputting characters occurs.

Meanwhile, in an environment in which a keyboard is always displayed on the touch screen, the step S1101 may not be performed. Or, the input apparatus is configured to consider that the event has been generated already.

If the event for displaying keyboard is determined to have been generated in the step S1101, the input apparatus may initially display a basic keyboard comprising keys for delegate consonants and delegate vowels on the touch screen at S1103. Here, the basic keyboard may have a configuration shown in FIG. 6 or a configuration shown in FIG. 10.

Then, the input apparatus may determine whether one of keys included in the displayed basic keyboard is selected or not at S1105. Here, when a user performs key operation such as a touch operation, a push operation, etc., the input apparatus may determine whether a key is selected or not and which key among keys included in the displayed keyboard is selected based on signals generated by the touch operation or the push operation.

When a key is determined to have been selected in the step S1105, the input apparatus may display a character (consonant or vowel) corresponding to the selected key in a display region for displaying inputted characters (for example, the display region 620 in FIG. 6 and the display region 720 in FIG. 7) at S1107.

Also, the input apparatus may determine whether keys (allocated for family consonants or vowels) related to the selected key (allocated for delegate consonant of vowel) are available at S1109. That is, when a user selects a delegate consonant or a delegate vowel, the input apparatus determines whether family consonants or vowels related to the selected delegate consonant or vowel exist or not.

If keys related to the key selected by a user are determined to be available at S1109, the input apparatus may additionally display at least one key related to the selected key in a predetermined region of the touch screen at S111. Here, the keys related to the selected key mean keys for allocated for family consonants or family vowels corresponding to the delegate consonant or the delegate vowel allocated to the selected key. The keys related to the selected key may be displayed in a predetermined area (for example, one of upper, lower, left, right, and lower-right side of the selected key) as expanded or popped-up.

Then, the input apparatus determines whether one of the related keys which are additionally displayed is selected or not a S1113. If one of the related keys which are additionally displayed is determined to be selected, the input apparatus displays a character corresponding to the key selected among the related keys in the display region for displaying inputted characters at S1115.

Then, the input apparatus determines whether an event for indicating termination of character input is generated or not at S1117. When the event is not determined to have been generated, the input apparatus returns to the step S1105 and performs the steps following the step S1105 again. Or, when the event is determined to have been generated, the input apparatus terminates processing for inputting characters. Here, when the event is determined to have been generated, the input apparatus may be configured to hide the displayed keyboard.

Meanwhile, a method for inputting characters according to the present invention may be implemented as program codes which can be executed by various computing means capable of processing digital information, and stored in a computer readable medium. The computer readable medium may include the program codes, data (such as data files and data structures) which are needed for executing the program codes. The program code stored in the medium may be specially designed and configured for the present invention. For example, the computer readable medium may include magnetic media such as hard disc, floppy disc, magnetic tape, etc., optical media such as CD-ROM, DVD, etc., magneto-optical media such as floptical disc, etc., and semiconductor devices such as ROM, RAM, flash memory, etc. Also, the medium may be transmission medium including carriers, through which the program codes and the data are transmitted, such as optic, metal wire, waveguide, and so on. For example, the program codes may include machine codes compiled by a compiler, and high-level language codes which can be executed by an interpreter in run time.

Hardware devices constituting the apparatus according to the present invention may be substituted with at least one software module. Similarly, software modules constituting the apparatus according to the present invention may be substituted with at least one hardware device.

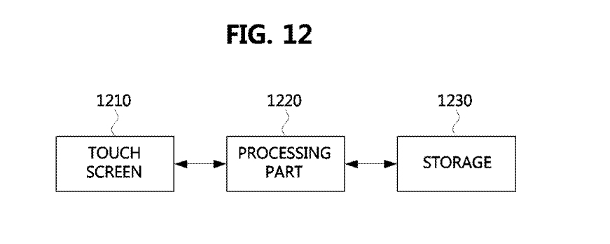

FIG. 12 is a block diagram to show a configuration of an apparatus for inputting characters according to an example embodiment of the present invention.

Referring to FIG. 12, an apparatus for inputting characters according to the present invention may comprise a touch screen 1210, a processing part 1220, and storage 1230.

The touch screen 1210 may display a keyboard for inputting characters in response to control of the processing part 1220, and provide touch input signals corresponding to keys touched by a user to the processing part 1220. Also, the touch screen 1210 may display characters allocated to the keys touched by a user according to control of the processing part 1220.

The touch screen 1210 may include a display region for displaying characters inputted by a user and a display region for displaying a keyboard.

The display region for displaying characters inputted by a user is a display region in which a character corresponding to a key which is currently touched and characters which have been already inputted are displayed. Also, the display region for displaying a keyboard is a display region in which keys for inputting consonants and keys for inputting vowels are displayed in the form of a keyboard shown in FIG. 6 or FIG. 10.

When an event for displaying keyboard is generated, the processing part 1220 may display a basic keyboard comprising keys for delegate consonants and delegate vowels on the touch screen 1210. Here, the processing part can 1220 determined whether the event for displaying keyboard is generated or not based on touch input signals provided from the touch screen 1210.

Then, when one of keys included in the displayed basic keyboard is selected, the processing part 1220 may display a character (consonant or vowel) corresponding to the selected key in the display region for displaying inputted characters of the touch screen 1210. Also, the processing part 1220 may determine whether keys (allocated for family consonants or vowels) related to the selected key (allocated for delegate consonant of vowel) are available. If keys related to the key selected by a user are available, the processing part 1220 may perform a process for displaying at least one key related to the selected key in a predetermined region of the touch screen additionally.

Then, when one of the related keys which are additionally displayed is determined to be selected, the processing part 1220 may display a character corresponding to the key selected among the related keys in the display region for displaying inputted characters of the touch screen 1210.

The processing part 1220 may perform the above procedures for inputting characters iteratively until an event for indicating an end of character input is generated.

The storage 1230 may be implemented with a non-volatile memory, and may store program codes including command instructions for executing the method for inputting characters which is described above. Also, the storage 1230 may be configured to store information about the consonant groups, the vowel groups, the delegate consonants, and the delegate vowels.

According to a method for inputting characters and an apparatus for the same, Korean consonants and vowels are grouped into at least one consonant-group and at least one vowel-group, and delegate consonants for each of the at least one consonant-group and delegate vowels for each of the at least one vowel-group are determined. Also, the delegate consonants and the delegate vowels are allocated to independent keys in Korean alphabetical order, and the keys are displayed in a touch screen. Also, when a key is selected among the displayed keys, at least one key corresponding to at least one family consonant belonging to the same group with the delegate consonant corresponding to the key selected among the displayed keys is displayed in a predetermined area (such as an upper area, an lower area, a left area, a right area, a lower-right area of the selected key) as expanded or popped up.

Therefore, all Korean consonants and vowels can be inputted by using a restricted number of keys, and inputted quickly and easily without any learning or training about positions of keys since positions of keys which are allocated to consonants and vowels can be easily recognized.

Also, since family consonants and vowels are displayed in areas adjacent to the selected key corresponding to one of the delegated consonants and vowels, efficiency of input may be enhanced with fingering distances shortened.

While the example embodiments of the present invention and their advantages have been described in detail, it should be understood that various changes, substitutions and alterations may be made herein without departing from the scope of the invention.

What is claimed is:

1. A method for inputting characters, performed in an apparatus based on touch screen, the method comprising:
grouping Korean consonants into at least one consonant-group and Korean vowels into at least one vowel-group, and determining delegate consonants each of which corresponds to each of the at least one consonant-group and delegate vowels each of which corresponds to each of the at least one vowel-group;
allocating the delegate consonants and the delegate vowels to independent keys in a predetermined order, and displaying the keys; and
displaying at least one key corresponding to at least one family consonant belonging to a same group with a delegate consonant corresponding to a key selected among the displayed keys.

2. The method of claim 1, wherein the Korean consonants and the Korean vowels are grouped based on at least one of shapes and sounds of the Korean consonants and the Korean vowels.

3. The method of claim 1, wherein the at least one consonant-group includes { [symbol] }, { [symbol] }, { [symbol] }, { [symbol] }, { [symbol] }, { [symbol] }, { [symbol] }, { [symbol] }, and { [symbol] }, and the delegate consonants for the at least one consonant-group are respectively configured as ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, and ‘ [symbol] ’.

4. The method of claim 1, wherein the delegate consonants for the Korean consonants are nine consonants, and displayed in a keyboard comprising 3 rows and 3 columns on the touch screen according to Korean alphabetical order.

5. The method of claim 1, wherein in the displaying at least one key corresponding to at least one family consonant belonging to the same group with the delegate consonant to the key selected among the displayed keys, the at least one key corresponding to the at least one family consonant is displayed in a predetermined position adjacent to the selected key, and the predetermined position includes upper side, lower side, left side, right side, and lower-right side of the selected key.

6. The method of claim 5, wherein the at least one key corresponding to the at least one family consonant is displayed in the left or right side of the selected key when the at least one family consonant is corresponding to a double consonant, and the at least one key corresponding to the at least one family consonant is displayed in the upper or lower side of the selected key when the at least one family consonant is corresponding to an aspirated consonant.

7. The method of claim 1, wherein the at least one vowel-group includes { [symbol] , [symbol] }, { [symbol] , [symbol] }, { [symbol] , [symbol] }, { [symbol] , [symbol] }, { [symbol] }, and { [symbol] }, and the delegate vowels for the at least one vowel-group are respectively configured as ‘ [symbol] ’, ‘ [symbol] ’, ‘ [symbol] ’, ‘ [symbol] ’, ‘ [symbol] ’, and ‘ [symbol] ’.

8. The method of claim 1, wherein the at least one vowel-group includes { [symbol] , [symbol] }, { [symbol] , [symbol] }, { [symbol] , [symbol] }, { [symbol] , [symbol] }, and { [symbol] , [symbol] }, and the delegate vowels for the at least one vowel-group are respectively configured as ‘ [symbol] ’, ‘ [symbol] ’, ‘ [symbol] ’, ‘ [symbol] ’, and ‘ [symbol] ’.

9. The method of claim 1, wherein the delegate consonants and the delegate vowels are displayed in a form of a QWERTY type keyboard, other consonants except the delegate consonants are not allocated to keys allocated to the delegate consonants, and other vowels except the delegate vowels are not allocated to keys allocated to the delegate vowels.

10. The method of claim 9, wherein in the displaying at least one key corresponding to at least one family consonant belonging to the same group with the delegate consonant to a key selected among the displayed keys, when a key corresponding to one of ‘ [symbol] ’, ‘ [symbol] ’, ‘ [symbol] ’, ‘ [symbol] ’, and ‘ [symbol] ’ is selected, at least one double consonant corresponding to a consonant allocated to the selected key is displayed in the upper side of the selected key.

11. The method of claim 1, further comprising displaying at least one key corresponding to at least one family vowel belonging to a same group with the delegate vowel corresponding to a key selected among the displayed keys.

12. The method of claim 11, wherein in the displaying at least one key corresponding to at least one family consonant belonging to the same group with the delegate consonant to the key selected among the displayed keys, a key corresponding to ‘ [symbol] ’ is displayed in the upper side of a key corresponding to ‘ [symbol] ’ when the key corresponding to ‘ [symbol] ’ is selected, and a key corresponding to ‘ [symbol] ’ is displayed in the upper side of a key corresponding to ‘ [symbol] ’ when the key corresponding to ‘ [symbol] ’ is selected.

13. An apparatus for inputting characters, comprising:
a touch screen displaying independent keys which are allocated to delegate consonants each of which corresponds to each of a plurality of Korean consonant-groups and delegate vowels each of which corresponds to each of a plurality of Korean vowel-groups, and generating a touch signal of a key selected among the displayed keys; and
a processing part receiving the touch signal, and controlling the touch screen to display at least one key corresponding to at least one family consonant belonging to a same group with the delegate consonant corresponding to the key selected among the displayed keys.

14. The apparatus of claim 13, wherein the touch screen displays the delegate consonants in a keyboard comprising 3 rows and 3 columns according to Korean alphabetical order.

15. The apparatus of claim 13, wherein the processing part controls the touch screen to display the at least one key corresponding to the at least one family consonant in a predetermined position adjacent to the selected key, and the predetermined position includes upper side, lower side, left side, right side, and lower-right side of the selected key.

16. The apparatus of claim 13, wherein the touch screen displays the delegate consonants and the delegate vowels in a form of a QWERTY type keyboard, and displays a double consonant corresponding to a delegate consonant allocated to the selected key in upper side of the selected key when the selected key is corresponding to one of ‘ [symbol] ’, ‘ [symbol] ’, ‘ [symbol] ’, ‘ [symbol] ’, and ‘ [symbol] ’ according to control of the processing part.

17. The apparatus of claim 13, wherein the touch screen displays the delegate consonants and the delegate vowels in a form of a QWERTY type keyboard, displays a key corresponding to ‘ [symbol] ’ in an upper side of a key corresponding to ‘ [symbol] ’ according to control of the processing part when the key corresponding to ‘ [symbol] ’ is selected, and displays a key corresponding to ‘ [symbol] ’ in an upper side of a key corresponding to ‘ [symbol] ’ according to control of the processing part when the key corresponding to ‘ [symbol] ’ is selected.
